(19) United States
(12) Patent Application Publication
(10) Pub. No.: US 2024/0321496 A1
(43) Pub. Date: Sep. 26, 2024

(54) Electromagnetic Linear Driver

(71) Applicants: Alex Deuitch, Westminster, CO (US); Dalton Hayes, Colorado Springs, CO (US)

(72) Inventors: Alex Deuitch, Westminster, CO (US); Dalton Hayes, Colorado Springs, CO (US)

(21) Appl. No.: 18/603,204

(22) Filed: Mar. 12, 2024

Related U.S. Application Data
(60) Provisional application No. 63/454,643, filed on Mar. 25, 2023.

(51) Int. Cl. H01F 7/08; B64G 1/00; H01F 7/16

(52) U.S. Cl. CPC H01F 7/081; B64G 1/002; H01F 7/1607

(57) ABSTRACT

A system for accelerating a payload is disclosed. An accelerator is configured to accelerate a captured external armature along a long axis and interior to the captured external armature. The accelerator is parallel to the captured external armature. The captured external armature is further configured to accelerate the payload. A stopper is configured to prevent the captured external armature from leaving the internal accelerator.

### CROSS-REFERENCE TO RELATED APPLICATIONS

The present application claims priority to U.S. provisional patent application No. 63/454,643.

### BACKGROUND OF THE INVENTION

Traditionally, repositioning of orbital assets traditionally requires expenditure of propellant on the object being repositioned. The object therefore has to carry propellant for the repositioning as well as for any subsequent maneuvers.

### TECHNICAL FIELD

The present disclosure relates generally to orbital maneuvering.

### SUMMARY

In a first aspect, a system for accelerating a payload is disclosed. An electromagnetic accelerator is configured to accelerate a captured armature along a long axis of and parallel to the electromagnetic accelerator. A captured armature is configured to accelerate the payload. A stopper is configured to prevent the captured armature from leaving the electromagnetic accelerator.

In a second aspect, a system for accelerating a payload is disclosed. A captured electromagnetic accelerator armature is configured to accelerate along a long axis and interior to an outer housing, the captured electromagnetic accelerator armature parallel to the outer housing. The captured electromagnetic accelerator armature is further configured to accelerate the payload. A stopper is configured to prevent the captured electromagnetic accelerator armature from leaving the external armature.

In a third aspect, a system for accelerating a payload is disclosed. An accelerator is configured to accelerate along a long axis and interior to a captured external armature, the accelerator parallel to the captured external armature. The armature is further configured to accelerate the payload. A stopper is configured to prevent the captured external armature from leaving accelerator.

Further aspects and embodiments are provided in the foregoing drawings, detailed description and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a linear accelerator in the ready position.

FIG. 2 is a side view of the linear accelerator of FIG. 1 in the deployed position.

FIG. 3 is a side view of a linear accelerator in the ready position.

FIG. 4 is a side view of the linear accelerator of FIG. 3 in the deployed position.

FIG. 5 is a side view of a linear accelerator in the ready position.

FIG. 6 is a side view of the linear accelerator of FIG. 5 in the deployed position.

FIG. 7 is a side view of a linear accelerator in the ready position.

FIG. 8 is a side view of a linear accelerator in the ready position.

FIG. 9 is a side view of the linear accelerator of FIG. 8 in the deployed position.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, a “payload” is meant to refer to an object that is delivered from one location to another. This may be an orbital payload or a planet-based payload.

As used herein, a “captured” armature is meant to refer to an armature that is controlled in a way to ensure that system is closed and retains its mass, and to not be deployed or launched externally from the launcher system.

As used herein, an “armature” is a part of the system that is being accelerated. This distinguishes it from the traditional definitions of armature. In orbital and planetary embodiments, the armature accelerates relative to the balance of the mass of the system.

Payloads, whether satellites, ordinance, spacecraft, raw materials, debris, de-orbited vehicles, or any other items described herein, require a means to deliver them. In a traditional payload delivery system, a propellant is expelled out of the back of the payload or a rocket carrying the payload. This limits payloads to be compatible with rockets. In some instances, this is a negative. For example, rockets vibrate, and some payloads could become damaged if they are vibrated. For planet-based launch, where personnel can carefully pack and test all components, this can be overcome, though it is costly. Currently, all vehicles in orbit require propellant-based architectures to impose accelerations for orbital transfers which has mass, power, size, and other requirements. For this and a multitude of reasons clear to a person of normal skill in the art, improvements to payload acceleration are critical.

The system disclosed herein overcomes all of these and many other issues clear to a person of normal skill in the art. The system is ideal for a non-atmospheric application, but is not precluded from operation in atmosphere. The system is therefore of high value for microgravity, hypogravity, orbit, asteroid, comet, lunar, or planetary operations.

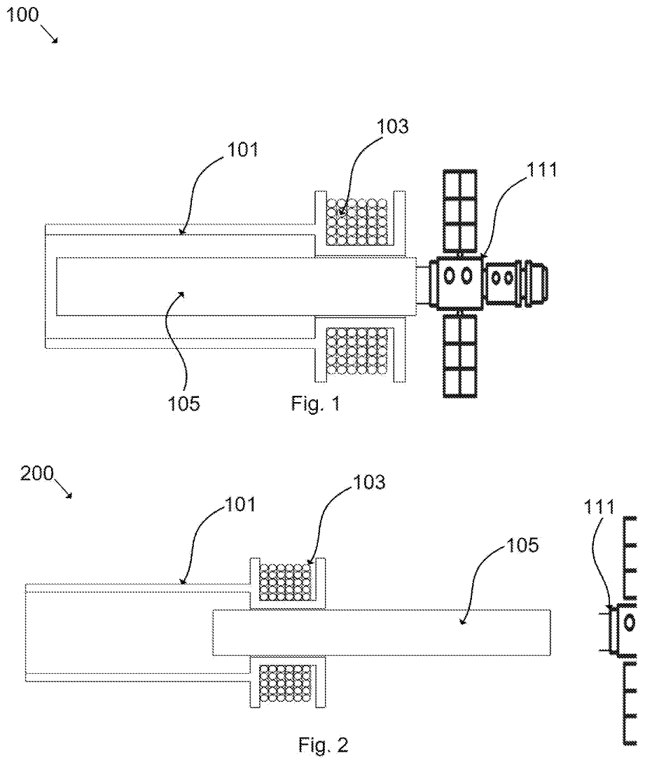

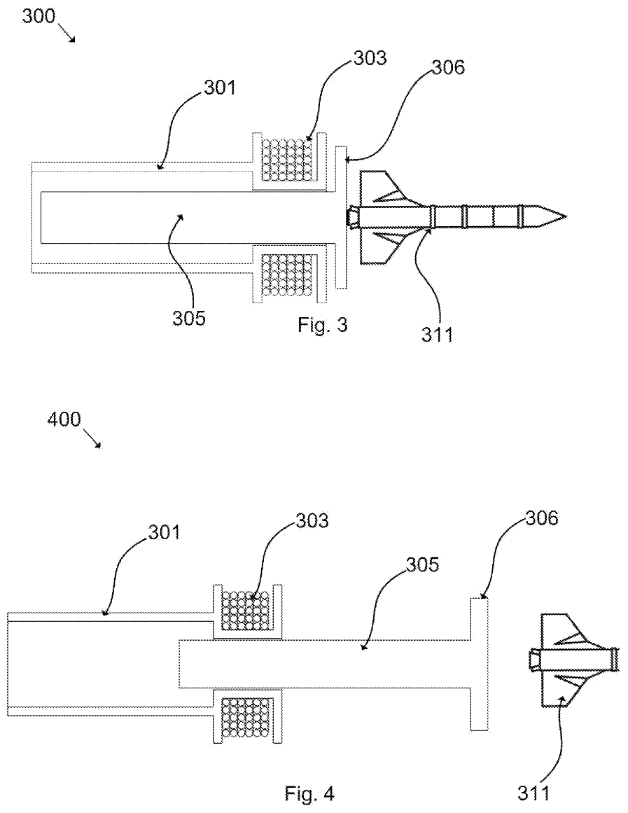

FIG. 1 is a side view of a linear accelerator in the ready position that may be used in one embodiment of the present invention. FIG. 2 is a side view of the linear accelerator of FIG. 1 in the deployed position. The system at 100 could be used in a variety of applications but will be described for use in orbit modification of a payload, satellite 111. A frame 101 includes an electromagnetic accelerator 103. In this embodiment, the frame 101 is significantly more massive than the satellite 111 and may be part of a space station or larger orbit modification platform. In other embodiments, the frame 101 and the satellite 101 may be roughly the same mass or even inverted in their mass ratio. The frame 101 may include thrusters for orbital and attitude maintenance of the frame 101 after payloads are accelerated. The electromagnetic accelerator 103 comprises coils through which electricity passes and is configured to induce a magnetic field. Captured armature 105 is magnetically susceptible and at least partially stays inside the electromagnetic accelerator 103 and frame 101. In some embodiments, the captured armature includes coils that allow it to be magnetically susceptible, rather than the armature structure itself being accelerated. The satellite 111 is placed at the external end of the captured armature 105, resulting in 100. When the electromagnetic accelerator 103 is engaged to drive the captured armature 105 to the right, the captured armature 105 and the satellite 111 are accelerated accordingly. When the captured armature 105 reaches the end point of its travels, the electromagnetic accelerator 103 switches polarity, now decelerating the captured armature 105, as in 200. In one embodiment, the satellite 111 was attached to the captured armature 105 while accelerating and detaches by digital signal from the station as soon as the deceleration begins. In another embodiment, the satellite 111 was placed against the captured armature 105 without being affixed and is held in place before the acceleration begins by maneuvering thrusters, magnetics, electronic capture, surface tensions, or other means. In either embodiment, as soon as the deceleration begins, the satellite 111, now accelerated to a desired velocity, is left to its new travel path. The electromagnetic accelerator 103 acts as a stopper to prevent the captured armature 105 from leaving the frame 101 and electromagnetic accelerator 103. The frame, now with a slightly modified orbit, can recover the previous orbit by traditional thrusters, or by rotating and accelerating another payload in an appropriate direction to restore its former orbit.

In other embodiments, the payload may be a spaceship, asteroid, space station, astronaut, processed goods, raw materials, ordinance, or a combination thereof.

In embodiments using coils, there may be a single coil or a plurality of coils.

The frame 101 may be cylindrical, square, or any other polygon in cross section.

In some embodiments, the captured armature is fully enclosed by the frame and electromagnetic accelerator, with the payload beginning inside the same.

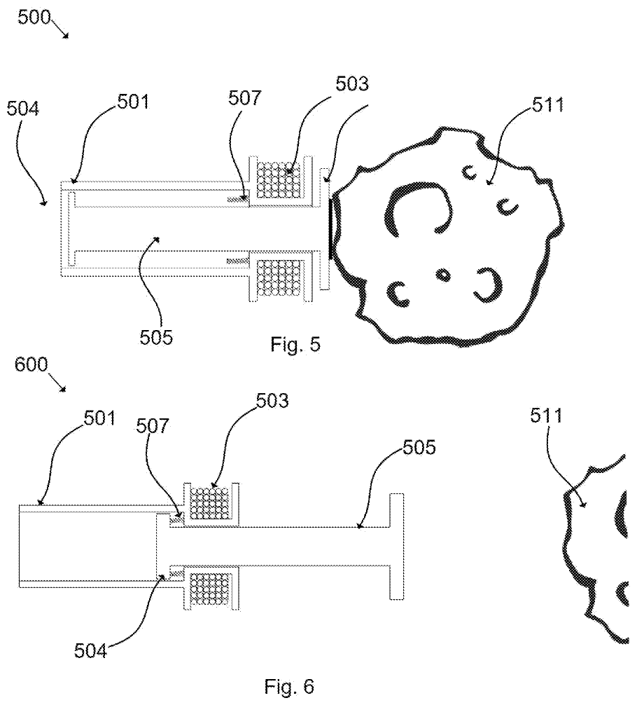

FIG. 3 is a side view of a linear accelerator in the ready position that may be used in one embodiment of the present invention. FIG. 4 is a side view of the linear accelerator of FIG. 3 in the deployed position. The system at 300 could be used in a variety of applications but will be described for use in orbit modification of a payload, rocket 311. A frame 301 includes an electromagnetic accelerator 303. In this embodiment, the frame 301 is significantly more massive than the rocket 311 and may be part of a space station or larger orbit modification platform. The frame 301 may include thrusters for orbital and attitude maintenance of the frame 301 after payloads are accelerated. The electromagnetic accelerator 303 comprises coils through which electricity passes and is configured to induce a magnetic field. Captured armature 305 is magnetically susceptible and at least partially stays inside the electromagnetic accelerator 303 and frame 301. The captured armature may also include coils that allow it to be magnetically susceptible, rather than the armature structure itself. The captured armature 305 includes a pusher plate 306 that increases the effective surface area of the captured armature 305 to accelerate large payloads. The rocket 311 is placed at the pusher plate 306, resulting in 300. When the electromagnetic accelerator 303 is engaged to drive the captured armature 305 to the right, the captured armature 305 and the rocket 311 are accelerated accordingly. When the captured armature 305 reaches the end point of its travels, the electromagnetic accelerator 303 switches polarity, now decelerating the captured armature 305, as in 400. In one embodiment, the rocket 311 was attached to the captured armature 305 while accelerating and detaches by digital signal from the station as soon as the deceleration begins. In another embodiment, the rocket 311 was placed against the captured armature 305 without being affixed and is held in place before the acceleration begins by maneuvering thrusters or other means. In either embodiment, as soon as the deceleration begins, the rocket 311, now accelerated to a desired velocity, is left to its new travel path. The electromagnetic accelerator 303 acts as a stopper to prevent the captured armature 305 from leaving the frame 301 and electromagnetic accelerator 303. The station, now with a slightly modified orbit, can recover the previous orbit by traditional thrusters, or by rotating and accelerating another payload in an appropriate direction to restore its former orbit.

FIG. 5 is a side view of a linear accelerator in the ready position that may be used in one embodiment of the present invention. FIG. 6 is a side view of the linear accelerator of FIG. 6 in the deployed position. The system at 500 could be used in a variety of applications but will be described for use in orbit modification of a payload, raw materials 511. A frame 501 includes an electromagnetic accelerator 503. In this embodiment, the frame 501 is equal or less massive than the raw materials 511 and may be part of a space station or rocket used for orbit modification. The frame 501 may include thrusters for orbital and attitude maintenance of the frame 501 after payloads are accelerated. The electromagnetic accelerator 503 comprises coils through which electricity passes and is configured to induce a magnetic field. Captured armature 505 is magnetically susceptible and at least partially stays inside the electromagnetic accelerator 503 and frame 501. The captured armature may also include coils that allow it to be magnetically susceptible, rather than the armature structure itself. The captured armature 505 includes a pusher plate 506 that increases the effective surface area of the captured armature 505 to accelerate large payloads. The system is maneuvered to position raw materials 511 at the pusher plate 506, resulting in 500. When the electromagnetic accelerator 503 is engaged to drive the captured armature 505 to the right, the captured armature 505 and the raw materials 511 are accelerated accordingly. When the captured armature 505 reaches the end point of its travels, the electromagnetic accelerator 503 switches polarity, now decelerating the captured armature 505, as in 600. In one embodiment, the raw materials 511 were attached to the captured armature 505 while accelerating and detaches by digital signal from the station or rocket as soon as the deceleration begins. In another embodiment, the captured armature 505 was placed against raw materials 511 without being affixed and is held in place before the acceleration begins by maneuvering thrusters on the station or rocket. In either embodiment, as soon as the deceleration begins, the raw materials 511, now accelerated to a desired velocity, are left to its new travel path. In this embodiment, the electromagnetic accelerator 503 may be used as a partial stopper but springs 507 are used as a final stopper. Extension 504 impacts the springs 507 to smooth deceleration of the captured armature 505. The station or rocket, now with a slightly modified orbit, can recover the previous orbit by traditional thrusters, or by rotating and accelerating another payload in an appropriate direction to restore its former orbit.

In one embodiment, the payload is mounted on a side of the captured armature. In another related embodiment, a second payload of similar weight to the first payload is mounted on an opposite side of the side of the captured armature.

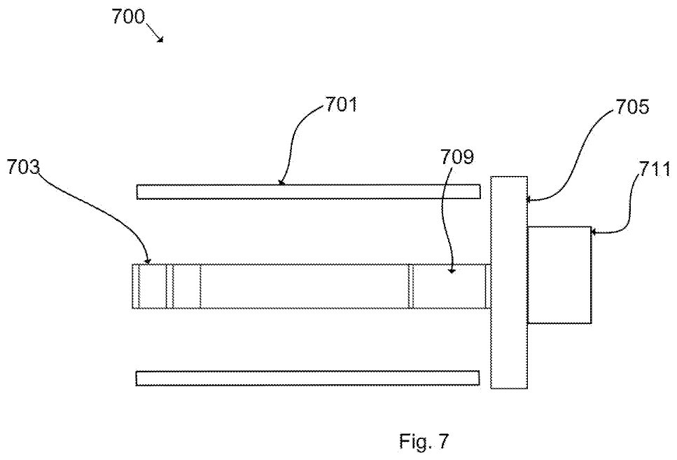

FIG. 7 is a side view of a linear accelerator in the ready position that may be used in one embodiment of the present invention. The system at 700 could be used in a variety of applications but will be described for use in launching a payload 711 from a planetary surface. The system is shown horizontally but may be oriented at any angle up to directly vertical. A frame 701, attached to the ground, acts as an external housing for a captured electromagnetic accelerator armature 703, which is part of a pusher assembly 705. The pusher assembly 705 further contains a damper 709. The electromagnetic accelerator 703 comprises coils through which electricity passes and is configured to induce a magnetic field. The frame 701 is magnetically susceptible and the electromagnetic accelerator 703 at least partially stays inside the frame 701. When the electromagnetic accelerator 703 is engaged to drive through the frame 701, the pusher assembly 705 and the payload 711 are accelerated accordingly. The damper 709 compresses during acceleration, reducing the acceleration the payload 711 feels initially. At the end of acceleration, the damper 709 decompresses, adding the reduced acceleration to the payload 711. When the pusher assembly 705 reaches the end point of its acceleration, the electromagnetic accelerator 703 switches polarity, now decelerating the pusher assembly 705. Gravity also helps decelerate the pusher assembly 705.

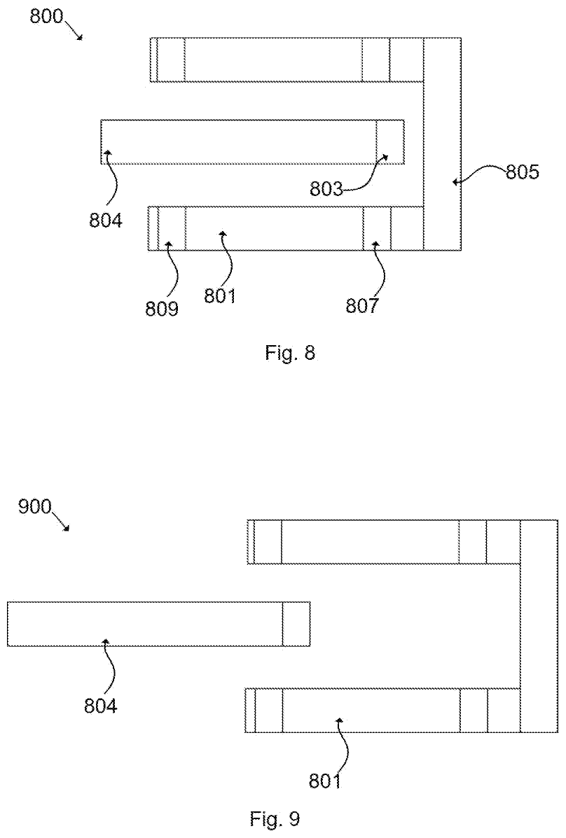

FIG. 8 is a side view of a linear accelerator in the ready position that may be used in one embodiment of the present invention. FIG. 9 is a side view of the linear accelerator of FIG. 8 in the deployed position. The system at 800 and 900 could be used in a variety of applications. The system is shown horizontally but may be oriented at any angle. A stationary launcher body 804, acts as an internal stabilizing rod for an electromagnetic accelerator 803, which is part of an armature 801. The armature 801 further contains a stopper 809. The electromagnetic accelerator 803 comprises coils through which electricity passes and is configured to induce a magnetic field. The armature 801 has accelerator driving coils 807. When the electromagnetic accelerator 803 is engaged to drive the armature 801, the pusher 805 and the payload are accelerated accordingly, as at 900. At the end of acceleration, the stopper 809 decelerates and stops the armature 801.

In all embodiments, the systems disclosed are capable of operating in low to zero gravity, in a vacuum in orbit, in space, on moons, or on planets, including planets with limited or no atmosphere.

The system can be used in a variety of embodiments on OTV's, servicing vehicles, launch vehicles, space stations or outposts, shuttles, be a hosted payload on any type of vehicle or be the primary focus of the vehicle itself. The system can also use any of the above vehicles as the payload, as well as raw materials, commodities, asteroids, comets, meteors, and other objects.

The launcher (linear electromagnetic driver) may contain one or more driving coils that will receive current to create a magnetic field to propel the armature. The coils can accept current in either direction to induce a force on the armature to move it forward in one direction, or backwards (or to stop movement) in the other direction. In some embodiments, the payload that is connected/located on the armature is partially, if not completely, external to the volume of the bore of the linear electromagnetic driver.

In some embodiments, an armature to be used in a linear electromagnetic driving system includes springs, dampers, or other types or designs of systems to reduce the forces and/or the accelerations felt by the object, payload, or spacecraft being pushed by the electromagnetic driving system. The dampening system may contain one or more stages to dampen different levels of forces or accelerations depending on the speed induced or the payload mass. In some embodiments, the armature to be used in a linear electromagnetic driving systems includes coils to be induced to move from the launcher (linear electromagnetic driver).

In some embodiments, the stopper is the electromagnetic accelerator further configured to decelerate the captured armature. In other embodiments, the stopper is a spring configured to slow and stop the captured armature.

In some embodiments, the payload is configured to detach from the captured armature as the captured armature reaches the stopper.

In some embodiments, the payload is a satellite, spaceship, asteroid, space station, astronaut, processed goods, raw materials, ordinance, man-made materials, or a combination thereof.

In some embodiments, the electromagnetic accelerator is a cylindrical tube.

In some embodiments, the captured armature is partially enclosed in the electromagnetic accelerator. In some embodiments, the captured armature further includes a pusher plate at an external end of the captured armature perpendicular to the long axis of the captured armature, wherein the pusher plate is configured to accelerate payloads.

In some embodiments, the captured armature further includes a magnetic, or non-magnetic internal damper configured to reduce the acceleration on the payload as the captured armature is accelerated.

In some embodiments, the payload is mounted to an end of the captured armature. In other embodiments, the payload is mounted on a side of the captured armature. In some instances in this second embodiment, a second payload of similar weight to the payload is mounted on an opposite side of the side of the captured armature.

The invention has been described with reference to various specific and preferred embodiments and techniques. Nevertheless, it is understood that many variations and modifications may be made while remaining within the spirit and scope of the invention.

1. A system for accelerating a payload, comprising:
an electromagnetic accelerator configured to accelerate a captured armature along a long axis of and parallel to the electromagnetic accelerator;
the captured armature configured to accelerate the payload;
a stopper configured to prevent the captured armature from leaving the electromagnetic accelerator.

2. The invention of claim 1, wherein the stopper is the electromagnetic accelerator further configured to decelerate the captured armature.

3. The invention of claim 1, wherein the stopper is a spring configured to slow and stop the captured armature.

4. The invention of claim 1, wherein the payload is configured to detach from the captured armature as the captured armature reaches the stopper.

5. The invention of claim 1, wherein the payload is a satellite, spaceship, asteroid, space station, astronaut, processed goods, raw materials, ordinance, man-made materials, or a combination thereof.

6. The invention of claim 1, wherein the captured armature is partially enclosed in the electromagnetic accelerator.

7. The invention of claim 1, wherein the captured armature further comprises a magnetic, or non-magnetic internal damper configured to reduce the acceleration on the payload as the captured armature is accelerated.

8. A system for accelerating a payload, comprising:
a captured electromagnetic accelerator armature configured to accelerate along a long axis and interior to an outer housing, the captured electromagnetic accelerator parallel to the outer housing;
the captured electromagnetic accelerator armature further configured to accelerate the payload;
a stopper configured to prevent the captured electromagnetic accelerator armature from leaving the external armature.

9. The invention of claim 8, wherein the stopper is the captured electromagnetic accelerator armature further configured to decelerate against the outer housing.

10. The invention of claim 8, wherein the stopper is a spring configured to slow and stop the captured electromagnetic accelerator armature.

11. The invention of claim 8, wherein the payload is configured to detach from the captured electromagnetic accelerator as the captured electromagnetic accelerator reaches a deceleration point.

12. The invention of claim 8, wherein the payload is a satellite, spaceship, asteroid, space station, astronaut, processed goods, raw materials, ordinance, or a combination thereof.

13. The invention of claim 8, wherein the captured electromagnetic accelerator armature further comprises an internal damper configured to reduce the acceleration on the payload as the captured electromagnetic accelerator armature accelerates.

14. A system for accelerating a payload, comprising:
an accelerator configured to accelerate a captured external armature, along a long axis and interior to the captured external armature, the accelerator parallel to the captured external armature;
the captured external armature further configured to accelerate the payload;
a stopper configured to prevent the captured external armature from leaving the internal accelerator.

15. The invention of claim 14, wherein the stopper is the electromagnetic accelerator further configured to decelerate the captured external armature.

16. The invention of claim 14, wherein the stopper is a spring configured to slow and stop the captured external armature.

17. The invention of claim 14, wherein the payload is a satellite, spaceship, asteroid, space station, astronaut, processed goods, raw materials, ordinance, or a combination thereof.

18. The invention of claim 14, wherein the electromagnetic accelerator is partially enclosed in the captured external armature and further comprises a pusher plate at an external end of the captured external armature perpendicular to the long axis of the electromagnetic accelerator, wherein the pusher plate is configured to accelerate the payload.

19. The invention of claim 18, wherein the captured armature further comprises a pusher plate at any location along the captured external armature perpendicular to the long axis of the electromagnetic accelerator, wherein the pusher plate is configured to accelerate the payload.

20. The invention of claim 14, wherein the captured external armature further comprises a damper configured to reduce the acceleration on the payload as the captured armature accelerates.
